(19) United States
(12) Patent Application Publication
(10) Pub. No.: US 2025/0391037 A1
(43) Pub. Date: Dec. 25, 2025

(54) INFORMATION PROCESSING APPARATUS, INFORMATION PROCESSING METHOD, AND NON-TRANSITORY COMPUTER-READABLE MEDIUM

(71) Applicant: NEC Corporation, Tokyo (JP)

(72) Inventors: Ryosuke SAKAI, Tokyo (JP); Soma SHIRAISHI, Tokyo (JP); Rin TAKANO, Tokyo (JP); Taichi HIRANO, Tokyo (JP)

(73) Assignee: NEC Corporation, Tokyo (JP)

(21) Appl. No.: 19/229,047

(22) Filed: Jun. 5, 2025

(30) Foreign Application Priority Data
Jun. 21, 2024 (JP) 2024-100776

(51) Int. Cl. G06T 7/246; G06T 7/73

(52) U.S. Cl. CPC G06T 7/251; G06T 7/75; G06T 2207/10016

(57) ABSTRACT

An object is to provide a technique capable of stably obtaining a correct physical quantity in a technique of converting a latent variable output from a world model into a physical quantity. An information processing apparatus includes a relationship derivation unit that derives, for an object to be inferred or predicted in a world model, a relationship between physical quantities from a pair of latent variables using a regression model having the pair of latent variables corresponding to different times output from the world model as an input, and having the relationship between the physical quantities respectively corresponding to the different times as an output.

### INCORPORATION BY REFERENCE

This application is based upon and claims the benefit of priority from Japanese patent application No. 2024-100776, filed on Jun. 21, 2024, the disclosure of which is incorporated herein in its entirety by reference.

### TECHNICAL FIELD

The present disclosure relates to an information processing apparatus, an information processing method, and an information processing program.

### BACKGROUND ART

A world model is known as a technique for inferring or predicting a state of an object included as a subject in a moving image. Examples of documents in which the world model is disclosed include Patent Literature 1.

Patent Literature 1: Japanese Unexamined Patent Application Publication No. 2023-143222

### SUMMARY

In the world model, the state of the object to be inferred or predicted is represented (encoded) as a latent variable. Therefore, in order to perform information processing using the world model, it is necessary to convert the latent variable output from the world model into a physical quantity such as a position or a pose. However, in a configuration using a regression model that converts a latent variable at a certain time into a physical quantity at the time (particularly, a physical quantity with respect to an absolute coordinate system), a regression result (the physical quantity obtained by the conversion) is unstable in some cases. As an example, in a case where an object has a symmetrical shape, an object coordinate system is unstable, resulting in an unstable regression result. The instability of the regression result is manifested as, for example, discontinuity of the regression result (a difference between physical quantities corresponding to two times is not reduced even if a difference between the two times is reduced and a difference between states corresponding to the two times is reduced).

The present disclosure has been made in view of the above problem, and an example object thereof is to provide a technique capable of stably obtaining a correct physical quantity in a technique of converting a latent variable output from a world model into a physical quantity.

An information processing apparatus according to an example aspect of the present disclosure includes a relationship derivation unit for deriving, for an object included in a world model representing a state of the object as a latent variable, a relationship between physical quantities from a pair of the latent variables using a regression model having the pair of latent variables corresponding to different times output from the world model as an input and having the relationship between the physical quantities respectively corresponding to the different times as an output.

An information processing apparatus according to a first example aspect of the present disclosure includes a model generation unit for generating a regression model that uses, for an object included in a world model representing a state of the object as a latent variable, a pair of the latent variables corresponding to different times output from the world model as an input and uses a relationship between physical quantities respectively corresponding to the different times as an output, wherein the model generation unit generates the regression model in such a manner that a correspondence between the input and the output of the regression model best approximates a correspondence between a pair of latent variables output from the world model and a relationship between the physical quantities acquired from a data set.

An information processing method according to a second example aspect of the present disclosure includes deriving, by a processor, for an object included in a world model representing a state of the object as a latent variable, a relationship between physical quantities from a pair of the latent variables using a regression model having the pair of latent variables corresponding to different times output from the world model as an input and having the relationship between the physical quantities respectively corresponding to the different times as an output.

An information processing method according to a third example aspect of the present disclosure includes generating, by a processor, a regression model that uses, for an object included in a world model representing a state of the object as a latent variable, a pair of the latent variables corresponding to different times output from the world model as an input and uses a relationship between physical quantities respectively corresponding to the different times as an output, wherein the processor generates the regression model in such a manner that a correspondence between the input and the output of the regression model best approximates a correspondence between a pair of latent variables output from the world model and a relationship between the physical quantities acquired from a data set.

An information processing program according to a fourth example aspect of the present disclosure causes a processor to execute a relationship derivation process of deriving, for an object included in a world model representing a state of the object as a latent variable, a relationship between physical quantities from a pair of the latent variables using a regression model having the pair of latent variables corresponding to different times output from the world model as an input and having the relationship between the physical quantities respectively corresponding to the different times as an output.

An information processing program according to a fifth example aspect of the present disclosure causes a processor to execute a model generation process of generating a regression model that uses, for an object included in a world model representing a state of the object as a latent variable, a pair of the latent variables corresponding to different times output from the world model as an input and uses a relationship between physical quantities respectively corresponding to the different times as an output, wherein, in the model generation process, the processor generates the regression model in such a manner that a correspondence between the input and the output of the regression model best approximates a correspondence between a pair of latent variables output from the world model and a relationship between the physical quantities acquired from a data set.

According to an example aspect of the present disclosure, there is an exemplary effect that the technique capable of stably obtaining the correct physical quantity can be provided in the technique of converting the latent variable output from the world model into the physical quantity.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of an information processing apparatus according to the present disclosure;

FIG. 2 is a flowchart illustrating a flow of an information processing method according to the present disclosure;

FIG. 3 is a block diagram illustrating a configuration of an information processing apparatus according to the present disclosure;

FIG. 4 is a flowchart illustrating a flow of an information processing method according to the present disclosure;

FIG. 5 is a block diagram illustrating a configuration of an information processing apparatus according to the present disclosure;

FIG. 6 is a flowchart illustrating a flow of an information processing method according to the present disclosure;

FIG. 7 is a block diagram illustrating a configuration of an information processing apparatus according to the present disclosure;

FIG. 8 is a flowchart illustrating a flow of an information processing method according to the present disclosure;

FIG. 9 is a block diagram illustrating a configuration of an information processing apparatus according to the present disclosure;

FIG. 10 is a flowchart illustrating a flow of an information processing method according to the present disclosure;

FIG. 11 is a block diagram illustrating a configuration of a computer that functions as the information processing apparatus according to the present disclosure; and

FIG. 12 is a schematic view illustrating operation of a world model used by the information processing apparatus according to the present disclosure.

### EXAMPLE EMBODIMENT

Hereinafter, embodiments will be exemplified. However, the present disclosure is not limited to example embodiments described below, and various alterations can be made within the scope described in the claims. For example, embodiments obtained by appropriately combining techniques (some or all of things or methods) adopted in the following example embodiments can also be included in the scope of the present disclosure. In addition, embodiments obtained by appropriately omitting some of the techniques adopted in the following example embodiments can also be included in the scope of the present disclosure. In addition, effects mentioned in the following example embodiments are examples of effects expected in the example embodiments, and do not define the extension of the present disclosure. That is, embodiments that do not achieve the effects mentioned in the following example embodiments can also be included in the scope of the present disclosure.

### [World Model]

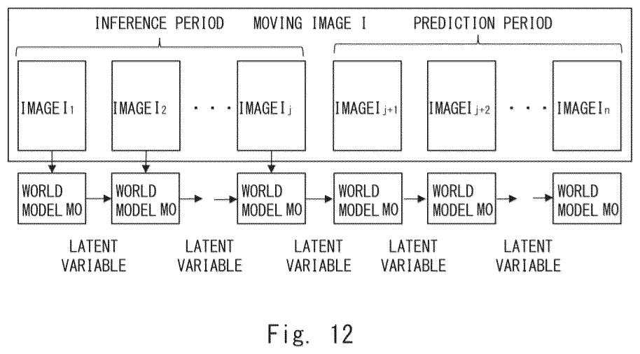

In the example embodiments described below, a world model M0 is used. Therefore, the world model M0 will be described with reference to FIG. 12 before describing the example embodiments. FIG. 12 is a schematic diagram illustrating the operation of the world model M0.

The world model is a model that is constructed by machine learning using limited information of the outside world (real world or virtual world) and approximates a structure of the outside world. In the present disclosure, a world model M0 constructed by object-centric representation learning is considered. In the object-centric representation learning, the world model M0 representing a state of an object Sⱼ as a latent variable is constructed using a moving image I including objects S₁, S₂, . . . , and Sₘ as subjects. Here, m is any natural number equal to or more than 1. The moving image I includes an image I₁ corresponding to a time t₁, an image I₂ corresponding to a time t₂ (t₁<t₂), . . . , and an image Iₙ corresponding to a time tₙ (tₙ₋₁<tₙ). Here, n is any natural number equal to or more than 2. Each image Iᵢ is a still image and is also called a frame or a frame image. Here, i is each a natural number of equal to or more than 1 and equal to or less than n. In a case where the world model M0 is a model that approximates a structure of the real world, the moving image I may be, for example, a live-action video representing the real world. In addition, in a case where the world model M0 is a model that approximates a structure of a virtual world, the moving image I can be, for example, a computer graphics (CG) video representing the virtual world. In the world model M0 constructed by the object-centric representation learning, regarding each of the objects Sⱼ included in the world model M0, a state (a physical quantity such as a position or a pose) at each time tᵢ is represented (encoded) as a latent variable Zᵢ^{(j)}. Hereinafter, a set of the objects S₁, S₂, . . . , and Sₘ included as the subjects in the moving image I, that is, a set of the objects S₁, S₂, . . . , and Sₘ included in the world model M0 is also referred to as an “object group {S₁, S₂, . . . , Sₘ}”.

The world model M0 derives a latent variable Zᵢ^{(j)}, which is a latent variable related to an object Sⱼ and corresponding to a time tᵢ, from an image Iᵢ corresponding to the time t₁ and a latent variable Zᵢ₋₁^{(j)}, which is a latent variable related to the object Sⱼ and corresponding to a time tᵢ₋₁, in an inference period. Here, j is any natural number of equal to or more than 1 and equal to or less than m. The world model M0 can perform the above inference on the respective objects Sⱼ in parallel. In this case, an output of the world model M0 at each time tᵢ included in the inference period is a set {Zᵢ^{(j)}|j=1, 2, . . . , m} of a latent variable Zᵢ⁽¹⁾ related to the object S₁, a latent variables Zᵢ⁽²⁾ related to the object S₂, . . . , and a latent variable Zᵢ^{(m)} related to the object Sₘ.

In addition, the world model M0 derives a latent variable Zᵢ^{(j)}, which is a latent variable related to an object Sⱼ and corresponding to a time tᵢ, from an image Iᵢ corresponding to the time tᵢ and a latent variable Zᵢ₋₁^{(j)}, which is a latent variable related to the object Sⱼ and corresponding to a time tᵢ₋₁, in a prediction period following the inference period. The world model M0 can perform the above prediction on the respective objects Sⱼ in parallel. In this case, an output of the world model M0 at each time tᵢ included in the prediction period is a set {Zᵢ^{(j)}|j=1, 2, . . . , m} of the latent variable Zᵢ⁽¹⁾ related to the object S₁, the latent variables Zᵢ⁽²⁾ related to the object S₂, . . . , and the latent variable Zᵢ^{(m)} related to the object Sₘ.

Note that examples of the known world model include ViMON, OP3, G-SWM, and GATSBI. However, the world model M0 that can be used in the example embodiments described below is not limited thereto. Any world model can be used in each of the example embodiments described below as long as the world model represents a state of an object as a latent variable.

As an example without limiting the present disclosure, the world model M0 can be utilized for, for example, (1) inference and prediction of motion of an object in a virtual space in a computer game, (2) inference and prediction of motion of an object in a real space in a physical simulation, (3) inference and prediction of an object (for example, an obstacle) in a real space in automated driving or control of a mobile body (an automobile, a ship, an aircraft, or the like), (4) inference and prediction of an object (for example, a workpiece) in a real space in control of a robot arm, and the like.

### First Example Embodiment

A first example embodiment, which is an example of an embodiment, will be described in detail with reference to the drawings. The present example embodiment is a basic form of each example embodiment described below. Note that an application range of each technique adopted in the present example embodiment is not limited to the present example embodiment. That is, each technique adopted in the present example embodiment can also be adopted in the other example embodiments included in the present disclosure within a range in which no particular technical problem occurs. In addition, each technique illustrated in the drawings referred to for describing the present example embodiment can also be employed in the other example embodiments included in the present disclosure within a range in which no particular technical problem occurs.

### (Configuration of Information Processing Apparatus)

A configuration of an information processing apparatus 1 will be described with reference to FIG. 1. FIG. 1 is a block diagram illustrating the configuration of the information processing apparatus 1.

As illustrated in FIG. 1, the information processing apparatus 1 includes a relationship derivation unit 11.

The relationship derivation unit 11 is a means for deriving, from a pair (Zᵢ^{(j)}, Z_{i′}^{(j)}) of latent variables Zᵢ^{(j)} and Z_{i′}^{(j)} corresponding to two different times tᵢ and t_{i′} (tᵢ<t_{i′}) output from the world model M0, a relationship ρ_{i,i′}^{(j)} between physical quantities oᵢ^{(j)} and o_{i′}^{(j)} corresponding to the two times tᵢ and t_{i′} for each object Sⱼ included in an object group {S₁, S₂, . . . , Sₘ} or for a specific object Sⱼ selected from the object group {S₁, S₂, . . . , Sₘ}. Note that the two times tᵢ and t_{i′} may be two adjacent (continuous) times, such as a time t₁ and a time t₂, or may be two non-adjacent (non-continuous) times, such as the time t₁ and a time t₃.

The relationship derivation unit 11 uses a regression model M1 to derive the relationship ρ_{i,i′}^{(j)} from the pair (Zᵢ^{(j)}, Z_{i′}^{(j)}). An input of the regression model M1 is the pair (Zᵢ^{(j)}, Z_{i′}^{(j)}) of latent variables Zᵢ^{(j)} and Z_{i′}^{(j)} output from the world model M0. An output of the regression model M1 is the relationship ρ_{i,i′}^{(j)} between the physical quantities oᵢ^{(j)} and o_{i′}^{(j)}. Note that the pair (Zᵢ^{(j)}, Z_{i′}^{(j)}) of two latent variables Zᵢ(j) and Z_{i′}^{(j)} may be input to the regression model M1 as one variable obtained by connecting these two latent variables Zᵢ^{(j)} and Z_{i′}^{(j)}. For example, in a case where each of the two latent variables Zᵢ(j) and Z_{i′}^{(j)} is represented by a three-dimensional vector, the pair (Zᵢ^{(j)}, Z_{i′}^{(j)}) of two latent variables Zᵢ^{(j)} and Z_{i′}^{(j)} may be input to the regression model M1 as a six-dimensional vector obtained by connecting the two three-dimensional vectors.

As an example without limiting the disclosure, the physical quantity oᵢ^{(j)} corresponding to each time tᵢ may be a position rⱼ(tᵢ) of the object Sⱼ at that time tᵢ. In this case, the relationship ρ_{i,i′}^{(j)} may be a displacement from the position rⱼ(tᵢ) of the object Sⱼ at the time tᵢ to a position rⱼ(tᵢ) of the object Sⱼ at the time t_{i′}. In this case, the position rⱼ(tᵢ), the position rⱼ(tᵢ), and the relationship ρ_{i,i′}^{(j)} are each represented by a three-dimensional vector, and a relationship of rⱼ(t_{i′})=ρ_{i,i′}^{(j)}+rⱼ(tᵢ) holds among these vectors.

In addition, as an example without limiting the disclosure, the physical quantity oᵢ^{(j)} corresponding to each time tᵢ may be a posture qⱼ(tᵢ) of the object Sⱼ at that time tᵢ.

In this case, the relationship ρ_{i,i′}^{(j)} may be a pose change from the pose qⱼ(tᵢ) of the object Sⱼ at the time tᵢ to a pose qⱼ(tᵢ) of the object Sⱼ at the time t_{i′}. In this case, the pose qⱼ(tᵢ), the pose qⱼ(tᵢ), and the relationship ρ_{i,i′}^{(j)} are each represented by a quaternion, and a relationship of qⱼ(t_{i′})=ρ_{i,i′}^{(j)}*qⱼ(tᵢ) holds among these quaternions.

In addition, as an example without limiting the disclosure, the physical quantity oᵢ^{(j)} corresponding to each time tᵢ may be a combination of the position rⱼ(tᵢ) and the pose qⱼ(tᵢ) of the object Sⱼ at the time tᵢ. In this case, the relationship ρ_{i,i′}^{(j)} can be a combination of the displacement from the position rⱼ(tᵢ) of the object Sⱼ at the time t₁ to the position rⱼ(tᵢ) of the object Sⱼ at the time t_{i′} and the pose change from the pose qⱼ(tᵢ) of the object Sⱼ at the time tᵢ to the pose qⱼ(tᵢ) of the object Sⱼ at the time t_{i′}.

Note that, instead of using the pair (Zᵢ^{(j)}, Z_{i′}^{(j)}) of latent variables Zᵢ^{(j)} and Z_{i′}^{(j)} as the input of the regression model M1, a difference Z_{i′}^{(j)}−Zᵢ^{(j)} between the latent variables Zᵢ^{(j)} and Z_{i′}^{(j)} may be used as the input of the regression model M1. In this case, the relationship derivation unit 11 derives the relationship ρ_{i,i′}^{(j)} between the physical quantities oᵢ^{(j)} and o_{i′}^{(j)} from the difference Z_{i′}^{(j)}−Zᵢ^{(j)} between the latent variables Zᵢ^{(j)} and Z_{i′}^{(j)} using the regression model M1.

In addition, instead of using the pair (Zᵢ^{(j)}, Z_{i′}^{(j)}) of latent variables Zᵢ^{(j)} and Z_{i′}^{(j)} as the input of the regression model M1, a set (Zᵢ^{(j)}, Z_{i′}^{(j)}, Z_{i′}^{(j)}−Zᵢ^{(j)}) of the latent variable Zᵢ^{(j)}, the latent variable Z_{i′}^{(j)}, and the difference Z_{i′}^{(j)}−Zᵢ^{(j)} may be used as the input of the regression model M1. In this case, the relationship derivation unit 11 derives the relationship ρ_{i,i′}^{(j)} between the physical quantities oᵢ^{(j)} and o_{i′}^{(j)} from the set (Zᵢ^{(j)}, Z_{i′}^{(j)}, Z_{i′}^{(j)}−Zᵢ^{(j)}) of the latent variable Zᵢ^{(j)}, the latent variable Z_{i′}^{(j)}, and the difference Zᵢ^{(j)}−Zᵢ^{(j)} using the regression model M1.

### (Flow of Information Processing Method)

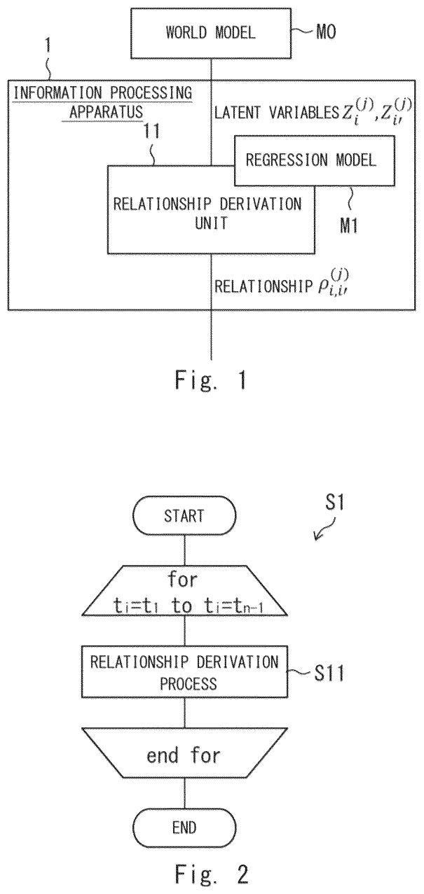

A flow of an information processing method S1 will be described with reference to FIG. 2. FIG. 2 is a flowchart illustrating the flow of the information processing method S1.

As illustrated in FIG. 2, the information processing method S1 includes a relationship derivation process S11. Note that the information processing method S1 is executed by the information processing apparatus 1 or a computer, for example.

The relationship derivation process S11 is a process for deriving a pair (Zᵢ^{(j)}, Z_{i′}^{(j)}) of latent variables Zᵢ^{(j)} and Z_{i′}^{(j)} corresponding to two different times tᵢ and t_{i′} (tᵢ<t_{i′}) output from the world model M0, a relationship ρ_{i,i′}^{(j)} between physical quantities oᵢ^{(j)} and o_{i′}^{(j)} corresponding to the two times tᵢ and t_{i′} for each object Sⱼ included in an object group {S₁, S₂, . . . , Sₘ} or for a specific object Sⱼ selected from the object group {S₁, S₂, . . . , Sₘ}. Here, the two times tᵢ and t_{i′} may be two continuous times, such as a time t₁ and a time t₂, or may be two non-continuous times, such as the time t₁ and a time t₃. Note that the relationship derivation process S11 is executed, for example, by the relationship derivation unit 11 of the information processing apparatus 1 or by a processor of the computer.

In the relationship derivation process S11, the regression model M1 is used to derive the relationship ρ_{i,i′}^{(j)} from the pair (Zᵢ^{(j)}, Z_{i′}^{(j)}). An input of the regression model M1 is the pair (Zᵢ^{(j)}, Z_{i′}^{(j)}) of latent variables Zᵢ^{(j)} and Z_{i′}^{(j)} output from the world model M0. An output of the regression model M1 is the relationship ρ_{i,i′}^{(j)} between the physical quantities oᵢ^{(j)} and o_{i′}^{(j)}. Note that the pair (Zᵢ^{(j)}, Z_{i′}^{(j)}) of two latent variables Zᵢ^{(j)} and Z_{i′}^{(j)} may be input to the regression model M1 as one variable obtained by connecting these two latent variables Zᵢ^{(j)} and Z_{i′}^{(j)}. For example, in a case where each of the two latent variables Zᵢ^{(j)} and Z_{i′}^{(j)} is represented by a three-dimensional vector, the pair (Zᵢ^{(j)}, Z_{i′}^{(j)}) of two latent variables Zᵢ^{(j)} and Z_{i′}^{(j)} may be input to the regression model M1 as a six-dimensional vector obtained by connecting the two three-dimensional vectors.

Note that, instead of using the pair (Zᵢ^{(j)}, Z_{i′}^{(j)}) of latent variables Zᵢ^{(j)} and Z_{i′}^{(j)} as the input of the regression model M1, a difference Z_{i′}^{(j)}−Zᵢ^{(j)} between the latent variables Zᵢ^{(j)} and Z_{i′}^{(j)} may be used as the input of the regression model M1. In this case, in the relationship derivation process S11, the relationship ρ_{i,i′}^{(j)} between the physical quantities oᵢ^{(j)} and o_{i′}^{(j)} is derived from the difference Z_{i′}^{(j)}−Zᵢ^{(j)} between the latent variables Zᵢ^{(j)} and Z_{i′}^{(j)} using the regression model M1.

In addition, instead of using the pair (Zᵢ^{(j)}, Z_{i′}^{(j)}) of latent variables Zᵢ^{(j)} and Z_{i′}^{(j)} as the input of the regression model M1, a set (Zᵢ^{(j)}, Z_{i′}^{(j)}, Z_{i′}^{(j)}−Zᵢ^{(j)}) of the latent variable Zᵢ^{(j)}, the latent variable Z_{i′}^{(j)} and the difference Z_{i′}^{(j)}−Zᵢ^{(j)} may be used as the input of the regression model M1. In this case, in the relationship derivation process S11, the relationship ρ_{i,i′}^{(j)} between the physical quantities oᵢ^{(j)} and o_{i′}^{(j)} is derived from the set (Zᵢ^{(j)}, Z_{i′}^{(j)}, Z_{i′}^{(j)}−Zᵢ^{(j)}) of the latent variable Zᵢ^{(j)}, the latent variable Z_{i′}^{(j)}, and the difference Z_{i′}^{(j)}−Zᵢ^{(j)} using the regression model M1.

Note that, as an example without limiting the present disclosure, FIG. 2 illustrates a flow of the information processing method S1 implemented in a case where i′=i+1, that is, in a case where a relationship ρ_{i,i+1}^{(j)} between physical quantities oᵢ^{(j)} and oᵢ₊₁^{(j)} corresponding to two times t₁ and tᵢ₊₁ adjacent to each other is derived in the relationship derivation process S11. In this case, the relationship derivation process S11 is repeated n−1 times, and relationships ρ_{1,2}^{(j)}, ρ_{2,3}^{(j)}, . . . , and ρ_{n-1,n}^{(j)} are sequentially derived.

Note that a time interval between the time tᵢ and the time t_{i′} is preferably short (fine) in order to enhance the stability of the regression. This is because, as the time interval between the time tᵢ and the time t_{i′} becomes longer, the uniqueness of the regression decreases, for example, it becomes more difficult to distinguish between pose changes of an object having the rotational symmetry (for example, distinguish between two rotations of no rotation and 180° rotation of the object having the rotational symmetry). In this regard, a configuration for deriving the relationship ρ_{i,i+1}^{(j)} between the physical quantities oᵢ^{(j)} and oᵢ₊₁^{(j)} corresponding to the two adjacent times tᵢ and tᵢ₊₁ is the best mode.

### (Effects of Information Processing Apparatus and Information Processing Method)

In the information processing apparatus 1 and the information processing method S1, the configuration in which the relationship ρ_{i,i′}^{(j)} between the physical quantities oᵢ^{(j)} and o_{i′}^{(j)} corresponding to the times tᵢ and t_{i′} is regressed from the latent variables Zᵢ^{(j)} and Z_{i′}^{(j)} corresponding to the different times tᵢ and t_{i′} is adopted instead of a configuration in which the physical quantity oᵢ^{(j)} corresponding to the time tᵢ is regressed from the latent variable Zᵢ^{(j)} corresponding to the time tᵢ. Therefore, regression that does not depend on a coordinate system representing a physical quantity is possible. Therefore, the instability of a regression result can be reduced. That is, the relationship ρ_{i,i′}^{(j)} between correct physical quantities oᵢ^{(j)}, o_{i′}^{(j)} corresponding to the times tᵢ and t_{i′} can be stably obtained.

In addition, in the configuration in which the physical quantity oᵢ^{(j)} corresponding to the time tᵢ is regressed from the latent variable Zᵢ^{(j)} corresponding to the time tᵢ, there may be a problem that the operation of a non-learning object (an object not included as a subject in an image used for learning of the regression model) cannot be guaranteed because an object coordinate system is not defined. On the other hand, such a problem hardly occurs in the information processing apparatus 1 and the information processing method S1 since the configuration in which the relationship ρ_{i,i′}^{(j)} between the physical quantities oᵢ^{(j)} and o_{i′}^{(j)} corresponding to the different times tᵢ and t_{i′} is regressed from the latent variables Zᵢ^{(j)} and Z_{i′}^{(j)} at the times tᵢ and t_{i′} is adopted.

As an example without limiting the present disclosure, the relationship ρ_{i,i′}^{(j)} between the physical quantities oᵢ^{(j)} and o_{i′}^{(j)} obtained by the information processing apparatus 1 can be utilized for, for example, (1) inference and prediction of motion of an object in a virtual space in a computer game, (2) inference and prediction of motion of an object in a real space in a physical simulation, (3) inference and prediction of an object (for example, an obstacle) in a real space in automated driving or control of a mobile body (an automobile, a ship, an aircraft, or the like), (4) inference and prediction of an object (for example, a workpiece) in a real space in control of a robot arm, and the like. In the case of application to the automated driving of a mobile body, it is possible to predict a displacement and a pose change of an obstacle (a person, an animal, another mobile body, or the like) using the information processing apparatus 1 and to automatically drive the mobile body such that the mobile body does not collide with the obstacle. In addition, in the case of application to the control of a robot arm, it is possible to predict a displacement and a pose change of a workpiece using the information processing apparatus 1 and to control the robot arm such that a hand provided at a distal end of the robot arm reaches the workpiece.

### Second Example Embodiment

A second example embodiment, which is an example of an embodiment, will be described in detail with reference to the drawings. Components having the same functions as the components described in the above-described example embodiments are denoted by the same reference signs, and the description thereof will be appropriately omitted. Note that an application range of each technique adopted in the present example embodiment is not limited to the present example embodiment. That is, each technique adopted in the present example embodiment can also be adopted in the other example embodiments included in the present disclosure within a range in which no particular technical problem occurs. In addition, each technique illustrated in each of the drawings referred to for describing the present example embodiment can be employed in the other example embodiments included in the present disclosure within a range in which no particular technical problem occurs.

### (Configuration of Information Processing Apparatus)

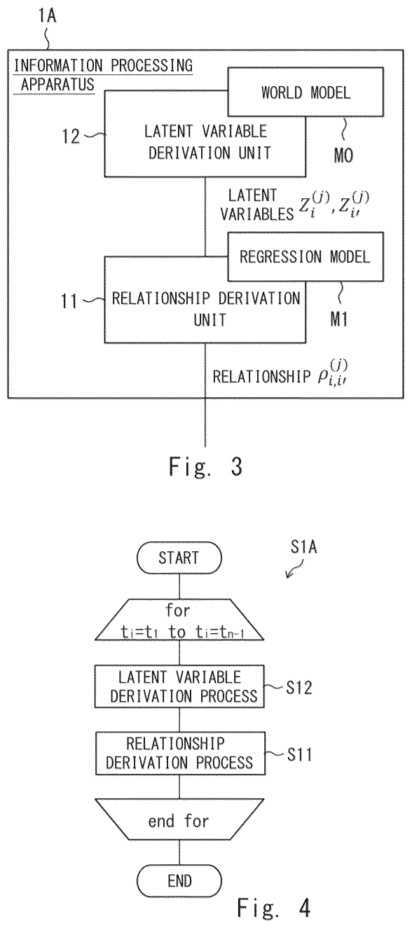

Next, a configuration of an information processing apparatus 1A will be described with reference to FIG. 3. FIG. 3 is a block diagram illustrating the configuration of the information processing apparatus 1A.

As illustrated in FIG. 3, the information processing apparatus 1A is obtained by adding a latent variable derivation unit 12 to the information processing apparatus 1 (see the first example embodiment).

The latent variable derivation unit 12 is a means for deriving latent variables Zᵢ^{(j)} and Zᵢ^{(j)} corresponding to two different times tᵢ and t_{i′} using the world model M0 for each object Sⱼ included in an object group {S₁, S₂, . . . , Sₘ} or for a specific object Sⱼ selected from the object group {S₁, S₂, . . . , Sₘ}. In a case where a time tᵢ is included in an inference period, the latent variable derivation unit 12 obtains a latent variable Zᵢ^{(j)} corresponding to the time tᵢ by inputting an image Iᵢ corresponding to the time tᵢ and a latent variable Zᵢ₋₁^{(j)} corresponding to a time tᵢ₋₁ to the world model M0. In addition, in a case where a time t_{i′} is included in the inference period, a latent variable Z_{i′}^{(j)} corresponding to the time t_{i′} is similarly obtained. On the other hand, in a case where a time tᵢ is included in a prediction period, the latent variable derivation unit 12 obtains a latent variable Zᵢ^{(j)} corresponding to the time tᵢ by inputting a latent variable Zᵢ₋₁^{(j)} corresponding to a time tᵢ₋₁ to the world model M0. In addition, in a case where a time t_{i′} is included in the prediction period, a latent variable Z_{i′}^{(j)} corresponding to the time t_{i′} is similarly obtained.

The relationship derivation unit 11 of the information processing apparatus 1A derives a relationship ρ_{i,i′}^{(j)} between physical quantities oᵢ^{(j)} and o_{i′}^{(j)} corresponding to the two different times tᵢ and t_{i′} from a pair (Zᵢ^{(j)}, Z_{i′}^{(j)}) of the latent variables Zᵢ^{(j)} and Z_{i′}^{(j)} corresponding to the two times tᵢ and t_{i′} derived by the latent variable derivation unit 12.

### (Flow of Information Processing Method)

A flow of an information processing method SIA will be described with reference to FIG. 4. FIG. 4 is a flowchart illustrating the flow of the information processing method S1A.

As illustrated in FIG. 4, the information processing method S1A is obtained by adding a latent variable derivation process S12 to the information processing method S1 (see the first example embodiment). Note that the information processing method SIA is executed by the information processing apparatus 1A or a computer, for example.

The latent variable derivation process S12 is executed before the relationship derivation process S11 as illustrated in FIG. 4.

The latent variable derivation process S12 is a process for deriving latent variables Zᵢ^{(j)} and Z_{i′}^{(j)} corresponding to two different times tᵢ and t_{i′} using the world model M0 for each object Sⱼ included in an object group {S₁, S₂, . . . , Sₘ} or for a specific object Sⱼ selected from the object group {S₁, S₂, . . . , Sₘ}. In a case where a time tᵢ is included in an inference period, in the latent variable derivation process S12, a latent variable Zᵢ^{(j)} corresponding to the time tᵢ is obtained by inputting an image Iᵢ corresponding to the time tᵢ and a latent variable Zᵢ₋₁^{(j)} corresponding to a time tᵢ₋₁ to the world model M0. In addition, in a case where a time t_{i′} is included in the inference period, a latent variable Z_{i′}^{(j)} corresponding to the time t_{i′} is similarly obtained. On the other hand, in a case where a time tᵢ is included in a prediction period, in the latent variable derivation process S12, a latent variable Zᵢ^{(j)} corresponding to the time tᵢ is obtained by inputting a latent variable Zᵢ₋₁^{(j)} corresponding to a time tᵢ₋₁ to the world model M0. In addition, in a case where a time t_{i′} is included in the inference period, a latent variable Z_{i′}^{(j)} corresponding to the time t_{i′} is similarly obtained. Note that the latent variable derivation process S12 is executed, for example, by the latent variable derivation unit 12 of the information processing apparatus 1A or by a processor of the computer.

In the relationship derivation process S11 of the information processing method S1A, a relationship ρ_{i,i′}^{(j)} between physical quantities oᵢ^{(j)} and o_{i′}^{(j)} corresponding to the two different times tᵢ and t_{i′} is derived from a pair (Zᵢ^{(j)}, Z_{i′}^{(j)}) of the latent variables Zᵢ^{(j)} and Z_{i′}^{(j)} corresponding to the two times tᵢ and t_{i′} derived in the latent variable derivation process S12.

Note that, as an example without limiting the present disclosure, FIG. 4 illustrates a flow of the information processing method SA implemented in a case where i′=i+1, that is, in a case where a relationship ρ_{i,i+1}^{(j)} between physical quantities oᵢ^{(j)} and oᵢ₊₁^{(j)} corresponding to two adjacent times tᵢ and tᵢ₊₁ is derived in the relationship derivation process S11. In this case, the relationship derivation process S11 is repeated n−1 times, and relationships ρ_{1,2}^{(j)}, ρ_{2,3}^{(j)}, . . . , and ρ_{n-1,n}^{(j)} are sequentially derived.

### (Effects of Information Processing Apparatus and Information Processing Method)

In the information processing apparatus 1A and the information processing method SIA, the configuration in which the relationship ρ_{i,i′}^{(j)} between the physical quantities oᵢ^{(j)} and o_{i′}^{(j)} corresponding to the times tᵢ and t_{i′} is regressed from the latent variables Zᵢ^{(j)} and Z_{i′}^{(j)} corresponding to the different times tᵢ and t_{i′} is adopted instead of a configuration in which the physical quantity oᵢ^{(j)} corresponding to the time tᵢ is regressed from the latent variable Zᵢ^{(j)} corresponding to the time tᵢ. Therefore, regression that does not depend on a coordinate system representing a physical quantity is possible. Therefore, the instability of a regression result can be reduced. That is, the relationship ρ_{i,i′}^{(j)} between correct physical quantities oᵢ^{(j)}, o_{i′}^{(j)} corresponding to the different times tᵢ and t_{i′} can be stably obtained.

In addition, in the configuration in which the physical quantity oᵢ^{(j)} corresponding to the time tᵢ is regressed from the latent variable Zᵢ^{(j)} corresponding to the time tᵢ, there may be a problem that the operation of a non-learning object (an object not included as a subject in an image used for learning of the regression model) cannot be guaranteed because an object coordinate system is not defined. On the other hand, such a problem hardly occurs in the information processing apparatus 1 and the information processing method S1 since the configuration in which the relationship ρ_{i,i′}^{(j)} between the physical quantities oᵢ^{(j)} and o_{i′}^{(j)} corresponding to the different times tᵢ and t_{i′} is regressed from the latent variables Zᵢ^{(j)} and Z_{i′}^{(j)} at the times tᵢ and t_{i′} is adopted.

### Third Example Embodiment

A third example embodiment, which is an example of an embodiment, will be described in detail with reference to the drawings. Components having the same functions as the components described in the above-described example embodiments are denoted by the same reference signs, and the description thereof will be appropriately omitted. Note that an application range of each technique adopted in the present example embodiment is not limited to the present example embodiment. That is, each technique adopted in the present example embodiment can also be adopted in the other example embodiments included in the present disclosure within a range in which no particular technical problem occurs. In addition, each technique illustrated in each of the drawings referred to for describing the present example embodiment can be employed in the other example embodiments included in the present disclosure within a range in which no particular technical problem occurs.

### (Configuration of Information Processing Apparatus)

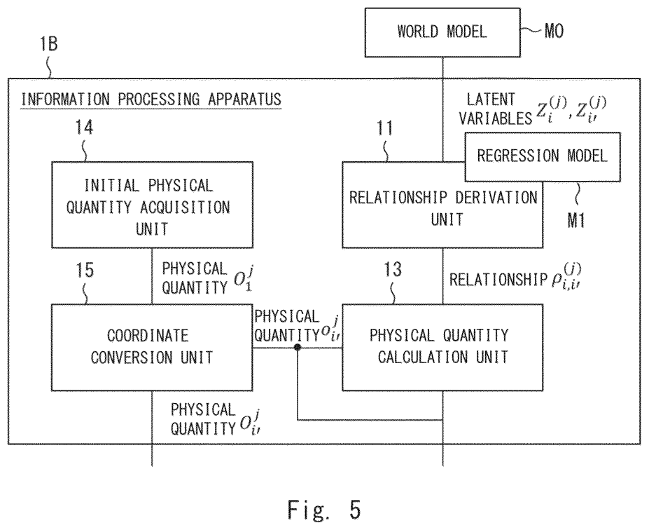

A configuration of an information processing apparatus 1B will be described with reference to FIG. 5. FIG. 5 is a block diagram illustrating the configuration of the information processing apparatus 1B.

As illustrated in FIG. 5, the information processing apparatus 1B is obtained by adding a physical quantity calculation unit 13, an initial physical quantity acquisition unit 14, and a coordinate conversion unit 15 to the information processing apparatus 1 (see the first example embodiment). Note that the information processing apparatus 1B may further include the latent variable derivation unit 12, similarly to the information processing apparatus 1A (see the second example embodiment).

The physical quantity calculation unit 13 is a means for calculating a physical quantity o_{i′}^{(j)} corresponding to a time t_{j′} from a physical quantity oᵢ^{(j)} corresponding to a time tⱼ calculated by the physical quantity calculation unit 13 and a relationship ρ_{i,i′}^{(j)} between the physical quantities oᵢ^{(j)} and o_{i′}^{(j)} corresponding to the two times tⱼ and t_{j′} derived by the relationship derivation unit 11 for each object Sⱼ included in an object group {S₁, S₂, . . . , Sₘ} or for a specific object Sⱼ selected from the object group {S₁, S₂, . . . , Sₘ}. Both the physical quantity oᵢ^{(j)} corresponding to the time tᵢ referred to by the physical quantity calculation unit 13 and the physical quantity o_{i′}^{(j)} corresponding to the time tᵢ calculated by the physical quantity calculation unit 13 are relative physical quantities with respect to a physical quantity o₁^{(j)} corresponding to the initial time t₁.

As an example without limiting the disclosure, the physical quantity oᵢ^{(j)} corresponding to each time tᵢ may be a position rⱼ(tᵢ) of the object Sⱼ at that time tᵢ. In this case, the relationship ρ_{i,i′}^{(j)} may be a displacement from the position rⱼ(tᵢ) of the object Sⱼ at the time tᵢ to a position rⱼ(t_{i′}) of the object Sⱼ at the time t_{i′}. In this case, the position rⱼ(tᵢ), the position rⱼ(t_{i′}), and the relationship ρ_{i,i′}^{(j)} are each represented by a three-dimensional vector. In this case, the physical quantity calculation unit 13 sets a position rⱼ(t₁) to 0 (vector), calculates a position rⱼ(t₂) according to rⱼ(t₂)=ρ_{1,2}^{(j)}+rⱼ(t₁), calculates a position rⱼ(t₃) according to rⱼ(t₃)=ρ_{2,3}^{(j)}+rⱼ(t₂), . . . , and calculates the position rⱼ(t_{i′}) according to rⱼ(t_{i′})=ρ_{i′-1,i′}^{(j)}+rⱼ(t_{i′-1}). Therefore, the position rⱼ(t_{i′})=ρ_{i′-1,i′}^{(j)}+ρ_{i′-2,i′-1}^{(j)}+ . . . +ρ_{1,2}^{(j)} at each time t_{i′} calculated by the physical quantity calculation unit 13 is a relative position with respect to the position rⱼ(t₁) at the initial time t₁.

In addition, as an example without limiting the disclosure, the physical quantity oᵢ^{(j)} corresponding to each time tᵢ may be a pose qⱼ (tᵢ) of the object Sⱼ at that time tᵢ. In this case, the relationship ρ_{i,i′}^{(j)} may be a pose change from the pose qⱼ (tᵢ) of the object Sⱼ at the time tᵢ to a pose qⱼ (t_{i′}) of the object Sⱼ at the time t_{i′}. In this case, the pose qⱼ (tᵢ), the pose qⱼ(t_{i′}), and the relationship ρ_{i,i′}^{(j)} are each represented by a quaternion. In this case, the physical quantity calculation unit 13 sets a pose qⱼ(t₁) to 1 (quaternion), calculates a pose qⱼ(t₂) according to qⱼ(t₂)=ρ_{1,2}^{(j)}*qⱼ(t₁), calculates a pose qⱼ(t₃) according to qⱼ (t₃)=ρ_{2,3}^{(j)}*qⱼ(t₂), . . . , and calculates the pose qⱼ (t_{i′}) according to qⱼ(t_{i′})=ρ_{i′-1,i′}^{(j)}*q_{i′-1} (t₁). Therefore, the pose qⱼ(t_{i′})=ρ_{i′-1,i′}^{(j)}*ρ_{i′-2,i′-1}^{(j)}* . . . *ρ_{1,2}^{(j)} at each time to calculated by the physical quantity calculation unit 13 is a relative pose with respect to the pose qⱼ(t₁) at the initial time t₁.

The initial physical quantity acquisition unit 14 is a means for acquiring a physical quantity O₁^{(j)} corresponding to the initial time t₁ for each object Sⱼ included in the object group {S₁, S₂, . . . , Sₘ} or for the specific object Sⱼ selected from the object group {S₁, S₂, . . . , Sₘ}. The physical quantity O₁^{(j)} corresponding to the initial time t₁ acquired by the initial physical quantity acquisition unit 14 is an absolute physical quantity.

As an example without limiting the disclosure, in a case where the physical quantity oᵢ^{(j)} corresponding to each time tᵢ is the position rⱼ(tᵢ) of the object Sⱼ at the time t₁, the initial physical quantity acquisition unit 14 acquires an absolute position Rⱼ (t₁) (vector) of the object Sⱼ at the initial time t₁.

In addition, as an example without limiting the disclosure, in a case where the physical quantity oᵢ^{(j)} corresponding to each time tᵢ is the pose qⱼ(tᵢ) of the object Sⱼ at the time tᵢ, the initial physical quantity acquisition unit 14 acquires an absolute pose Qⱼ (t₁) (quaternion) of the object Sⱼ at the initial time t₁.

The coordinate conversion unit 15 is a means for converting the relative physical quantity o_{i′}^{(j)} corresponding to the time t_{j′} calculated by the physical quantity calculation unit 13 into the absolute physical quantity O_{i′}^{(j)} corresponding to the time t_{j′} by using the absolute physical quantity O₁^{(j)} corresponding to the initial time t₁ acquired by the initial physical quantity acquisition unit 14 for each object Sⱼ included in the object group {S₁, S₂, . . . , Sₘ} or for the specific object Sⱼ selected from the object group {S₁, S₂, . . . , Sₘ}.

As an example without limiting the disclosure, in a case where the physical quantity oᵢ^{(j)} corresponding to each time tᵢ is the position rⱼ(tᵢ) of the object Sⱼ at the time tᵢ, the coordinate conversion unit 15 converts a relative position r_{i′}^{(j)} at the time t_{j′} calculated by the physical quantity calculation unit 13 into an absolute position R_{i′}^{(j)}=R₁^{(j)}+r_{i′}^{(j)} at the time t_{j′} by using an absolute position R₁^{(j)} at the initial time t₁ acquired by the initial physical quantity acquisition unit 14.

In addition, as an example without limiting the disclosure, in a case where the physical quantity oᵢ^{(j)} corresponding to each time tᵢ is the pose qⱼ(tᵢ) of the object Sⱼ at the time tᵢ, the coordinate conversion unit 15 converts a relative pose q_{i′}^{(j)} corresponding to the time t_{j′} calculated by the physical quantity calculation unit 13 into an absolute pose Q_{i′}^{(j)}=Q₁^{(j)}*q_{i′}^{(j)} at the time t_{j′} by using an absolute pose Q₁^{(j)} at the initial time t₁ acquired by the initial physical quantity acquisition unit 14.

Note that the information processing apparatus 1B may be configured to (1) exclusively output the relative physical quantity oᵢ^{(j)} corresponding to each time tᵢ, (2) exclusively output the absolute physical quantity Oᵢ^{(j)} corresponding to each time tᵢ, (3) output both the relative physical quantity oᵢ^{(j)} and the absolute physical quantity Oᵢ(j) corresponding to each time tᵢ, or (4) output a physical quantity selected by a user out of the relative physical quantity oᵢ^{(j)} and the absolute physical quantity Oᵢ^{(j)} corresponding to each time tᵢ.

In the case of exclusively outputting the relative physical quantity oᵢ^{(j)} corresponding to each time tᵢ, the initial physical quantity acquisition unit 14 and the coordinate conversion unit 15 can be omitted from the information processing apparatus 1B. In addition, in the case of outputting the physical quantity selected by the user out of the relative physical quantity oᵢ^{(j)} and the absolute physical quantity Oᵢ^{(j)} corresponding to each time tᵢ, it is preferable to add, to the information processing apparatus 1B, a switching means for switching a physical quantity to be output to the physical quantity selected by the user.

### (Flow of Information Processing Method)

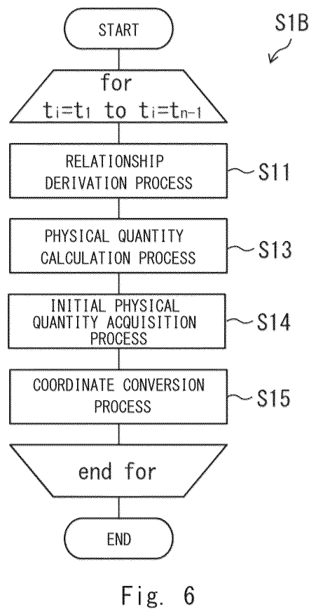

A flow of an information processing method S1B will be described with reference to FIG. 6. FIG. 6 is a flowchart illustrating the flow of the information processing method S1B.

As illustrated in FIG. 6, the information processing method S1B is obtained by adding a physical quantity calculation process S13, an initial physical quantity acquisition process S14, and a coordinate conversion process S15 to the information processing method S1 (see the first example embodiment). The information processing method S1B may further include the latent variable derivation process S12, similarly to the information processing method SIA (see the second example embodiment). Note that the information processing method S1B is executed by the information processing apparatus 1B or a computer, for example.

As illustrated in FIG. 6, the physical quantity calculation process S13, the initial physical quantity acquisition process S14, and the coordinate conversion process S15 are executed after the relationship derivation process S11. However, the physical quantity calculation process S13 and the initial physical quantity acquisition process S14 are executed in any order. That is, the initial physical quantity acquisition process S14 may be executed after the physical quantity calculation process S13 is executed, or the physical quantity calculation process S13 may be executed after the initial physical quantity acquisition process S14 is executed. Alternatively, the physical quantity calculation process S13 and the initial physical quantity acquisition process S14 may be executed in parallel.

The physical quantity calculation process S13 is a process for calculating a physical quantity o_{i′}^{(j)} corresponding to a time t_{j′} from a physical quantity oᵢ^{(j)} corresponding to a time tⱼ calculated in the physical quantity calculation process S13 of the previous cycle and a relationship ρ_{i,i′}^{(j)} between the physical quantities oᵢ^{(j)} and o_{i′}^{(j)} corresponding to the two times tⱼ and t_{j′} derived in the relationship derivation process S11 of the current cycle for each object Sⱼ included in an object group {S₁, S₂, . . . , Sₘ} or a specific object Sⱼ selected from the object group {S₁, S₂, . . . , Sₘ}. Both the physical quantity oᵢ^{(j)} corresponding to the time tᵢ referred to in the physical quantity calculation process S13 and the physical quantity o_{i′}^{(j)} corresponding to the time t_{i′} calculated in the physical quantity calculation process S13 are relative physical quantities with respect to a physical quantity o₁^{(j)} corresponding to the initial time t₁. Note that the physical quantity calculation process S13 is executed, for example, by the physical quantity calculation unit 13 of the information processing apparatus 1B or by a processor of the computer.

The initial physical quantity acquisition process S14 is a process for acquiring a physical quantity O₁^{(j)} corresponding to the initial time t₁ for each object Sⱼ included in the object group {S₁, S₂, . . . , Sₘ} or for the specific object Sⱼ selected from the object group {S₁, S₂, . . . , Sₘ}. The physical quantity O₁^{(j)} corresponding to the initial time t₁ acquired in the initial physical quantity acquisition process S14 is an absolute physical quantity. Note that the initial physical quantity acquisition process S14 is executed, for example, by the initial physical quantity acquisition unit 14 of the information processing apparatus 1B or by the processor of the computer.

The coordinate conversion process S15 is a process for converting the relative physical quantity o_{i′}^{(j)} corresponding to the time t_{j′} calculated in the physical quantity calculation process S13 into the absolute physical quantity Oᵢ^{(j)} corresponding to the time t_{j′} using the absolute physical quantity O₁^{(j)} corresponding to the initial time t₁ acquired in the initial physical quantity acquisition process S14 for each object Sⱼ included in the object group {S₁, S₂, . . . , Sₘ} or for the specific object Sⱼ selected from the object group {S₁, S₂, . . . , Sₘ}. Note that the coordinate conversion process S15 is executed, for example, by the coordinate conversion unit 15 of the information processing apparatus 1B or by the processor of the computer.

Note that, as an example without limiting the present disclosure, FIG. 6 illustrates a flow of the information processing method S1B implemented in a case where i′=i+1, that is, in a case where a relationship ρ_{i,i+1}^{(j)} between physical quantities oᵢ^{(j)} and oᵢ₊₁^{(j)} corresponding to two adjacent times tᵢ and tᵢ₊₁ is derived in the relationship derivation process S11. In this case, the relationship derivation process S11 is repeated n−1 times, and an absolute physical quantity O₂^{(j)}, an absolute physical quantities O₃^{(j)}, . . . , and an absolute physical quantity Oₙ^{(j)} are sequentially calculated.

Note that the information processing method SIB may be configured to (1) exclusively output the relative physical quantity oᵢ^{(j)} corresponding to each time tᵢ, (2) exclusively output the absolute physical quantity Oᵢ^{(j)} corresponding to each time tᵢ, (3) output both the relative physical quantity oᵢ^{(j)} and the absolute physical quantity Oᵢ^{(j)} corresponding to each time tᵢ, or (4) output a physical quantity selected by a user out of the relative physical quantity oᵢ^{(j)} and the absolute physical quantity Oᵢ^{(j)} corresponding to each time tᵢ.

In the case of exclusively outputting only the relative physical quantity oᵢ^{(j)} corresponding to each time tᵢ, the initial physical quantity acquisition process S14 and the coordinate conversion process S15 can be omitted from the information processing method S1B. In addition, in the case of outputting the physical quantity selected by the user out of the relative physical quantity oᵢ^{(j)} and the absolute physical quantity Oᵢ^{(j)} corresponding to each time tᵢ, it is preferable to add, to the information processing method S1B, a switching process of switching a physical quantity to be output to the physical quantity selected by the user.

### (Effects of Information Processing Method and Information Processing Apparatus)

In the information processing apparatus 1B and the information processing method S1B, the configuration in which the relationship ρ_{i,i′}^{(j)} between the physical quantities oᵢ^{(j)} and o_{i′}^{(j)} corresponding to the times tᵢ and t_{i′} is regressed from the latent variables Zᵢ^{(j)} and Z_{i′}^{(j)} corresponding to the different times tᵢ and t_{i′} is adopted instead of a configuration in which the physical quantity oᵢ^{(j)} corresponding to the time tᵢ is regressed from the latent variable Zᵢ^{(j)} corresponding to the time tᵢ. Therefore, regression that does not depend on a coordinate system representing a physical quantity is possible. Therefore, the instability of a regression result can be reduced. As a result, correct physical quantities o_{i′}^{(j)} and O_{i′}^{(j)} corresponding to the time t_{i′} can be stably obtained.

In addition, in the configuration in which the physical quantity oᵢ^{(j)} corresponding to the time tᵢ is regressed from the latent variable Zᵢ^{(j)} corresponding to the time tᵢ, there may be a problem that the operation of a non-learning object (an object not included as a subject in an image used for learning of the regression model) cannot be guaranteed because an object coordinate system is not defined. On the other hand, such a problem hardly occurs in the information processing apparatus 1B and the information processing method S1B since the configuration in which the relationship ρ_{i,i′}^{(j)} between the physical quantities oᵢ^{(j)} and o_{i′}^{(j)} corresponding to the different times tᵢ and t_{i′} is regressed from the latent variables Zᵢ^{(j)} and Z_{i′}^{(j)} at the times tᵢ and t_{i′} is adopted.

As an example without limiting the present disclosure, the physical quantities o_{i′}^{(j)} and O_{i′}^{(j)} obtained by the information processing apparatus 1B can be utilized for, for example, (1) inference and prediction of motion of an object in a virtual space in a computer game, (2) inference and prediction of motion of an object in a real space in a physical simulation, (3) inference and prediction of an object (for example, an obstacle) in a real space in automated driving or control of a mobile body (an automobile, a ship, an aircraft, or the like), (4) inference and prediction of an object (for example, a workpiece) in a real space in control of a robot arm, and the like. In the case of application to the automated driving of a mobile body, it is possible to predict a position and a pose of an obstacle (a person, an animal, another mobile body, or the like) using the information processing apparatus 1 and to automatically drive the mobile body such that the mobile body does not collide with the obstacle. In addition, in the case of application to the control of a robot arm, it is possible to predict a position and a pose of a workpiece using the information processing apparatus 1 and to control the robot arm such that a hand provided at a distal end of the robot arm reaches the workpiece.

### Fourth Example Embodiment

A fourth example embodiment, which is an example of an embodiment, will be described in detail with reference to the drawings. The present example embodiment is a basic form of each example embodiment described below. Note that an application range of each technique adopted in the present example embodiment is not limited to the present example embodiment. That is, each technique adopted in the present example embodiment can also be adopted in the other example embodiments included in the present disclosure within a range in which no particular technical problem occurs. In addition, each technique illustrated in the drawings referred to for describing the present example embodiment can also be employed in the other example embodiments included in the present disclosure within a range in which no particular technical problem occurs.

### (Configuration of Information Processing Apparatus)

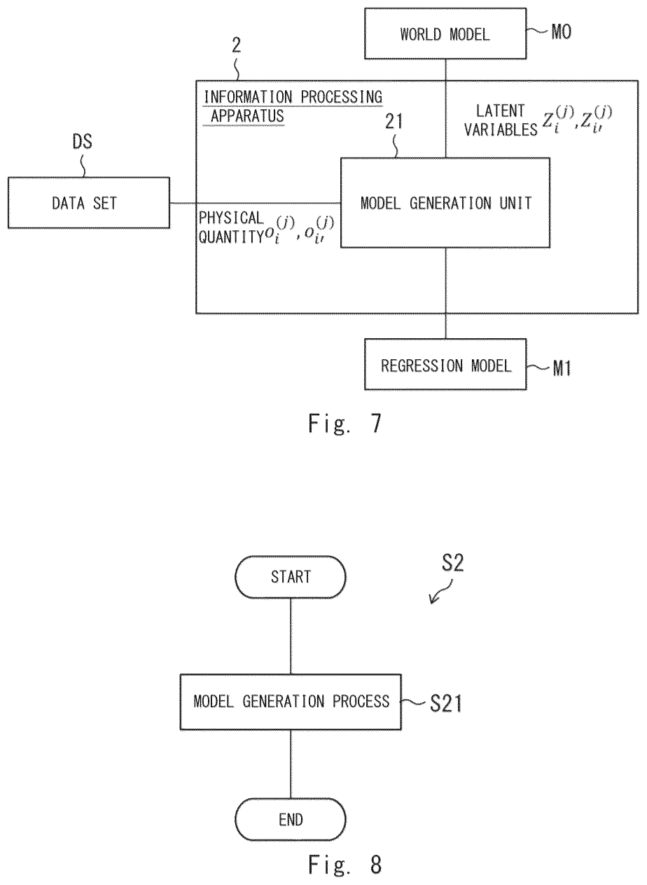

A configuration of an information processing apparatus 2 will be described with reference to FIG. 7. FIG. 7 is a block diagram illustrating the configuration of the information processing apparatus 2.

As illustrated in FIG. 7, the information processing apparatus 2 includes a model generation unit 21.

The model generation unit 21 is a means for generating the regression model M1 for deriving, from a pair (Zᵢ^{(j)}, Z_{i′}^{(j)}) of latent variables Zᵢ^{(j)} and Z_{i′}^{(j)} corresponding to two different times tᵢ and t_{i′} (tᵢ<t_{i′}) output from the world model M0, a relationship ρ_{i,i′}^{(j)} between physical quantities oᵢ^{(j)} and o_{i′}^{(j)} corresponding to the two times tᵢ and t_{i′} for each object Sⱼ included in an object group {S₁, S₂, . . . , Sₘ} or for a specific object Sⱼ selected from the object group {S₁, S₂, . . . , Sₘ}. Note that the two times tᵢ and t_{i′} may be two adjacent (continuous) times, such as a time t₁ and a time t₂, or may be two non-adjacent (non-continuous) times, such as the time t₁ and a time t₃.

In order to generate the regression model M1, the model generation unit 21 uses a data set DS including the physical quantity oᵢ^{(j)} corresponding to each time tᵢ for each object Sⱼ included in the object group {S₁, S₂, . . . , Sₘ} or for the specific object Sⱼ selected from the object group {S₁, S₂, . . . , Sₘ}. The model generation unit 21 trains the regression model M1 such that a correspondence between input and output of the regression model M1 best approximates a correspondence between a pair (Zᵢ^{(j)}, Z_{i′}^{(j)}) of latent variables Zᵢ^{(j)} and Z_{i′}^{(j)} corresponding to two different times tᵢ and t_{i′} acquired from the world model M0 and a relationship ρ_{i,i′}^{(j)} of physical quantities oᵢ^{(j)} and o_{i′}^{(j)} corresponding to the two times tᵢ and t_{i′} acquired from the data set DS.

Note that a physical quantity corresponding to each time tᵢ constituting the data set DS may be a relative physical quantity oᵢ^{(j)} or an absolute physical quantity Oᵢ^{(j)}. This is because a relationship between absolute physical quantities Oᵢ^{(j)} and O_{i′}^{(j)} corresponding to the two times tᵢ and t_{i′} coincides with the relationship ρ_{i,i′}^{(j)} between the relative physical quantities oᵢ^{(j)} and o_{i′}^{(j)} corresponding to the two times t₁ and t_{i′}.

In order to enhance the stability of the regression, it is preferable to generate the regression model M1 in which the correspondence between input and output satisfies the following condition (1). In addition, in order to enhance the stability of the regression and further reduce an accumulation error, it is preferable to generate the regression model M1 in which the correspondence between the input and output satisfies the following condition (2) in addition to the following condition (1).

Condition (1): The correspondence of input and output of the regression model M1 best approximates a correspondence between a pair (Zᵢ^{(j)}, Zᵢ₊₁^{(j)}) of latent variables Zᵢ^{(j)} and Zᵢ₊₁^{(j)} corresponding to two adjacent times tᵢ and tᵢ₊₁ acquired from the world model M0 and a relationship ρ_{i,i+1}^{(j)} between physical quantities oᵢ^{(j)} and oᵢ₊₁^{(j)} corresponding to the two times tᵢ and tᵢ₊₁ acquired from the data set DS.

Condition (2): The correspondence of input and output of the regression model M1 best approximates a correspondence between a pair (Zᵢ^{(j)}, Zᵢ₊₁^{(j)} of latent variables Zᵢ^{(j)} and Zᵢ₊ₖ^{(j)} corresponding to two non-adjacent times tᵢ and tᵢ₊ₖ acquired from the world model M0 and a relationship ρ_{i,i+k}^{(j)} between physical quantities oᵢ^{(j)} and oᵢ₊ₖ^{(j)} corresponding to the two times tᵢ, tᵢ₊ₖ acquired from the data set DS. Here, k is a natural number equal to or more than 2.

As an example without limiting the disclosure, the physical quantity oᵢ^{(j)} corresponding to each time tᵢ may be a position rⱼ(tᵢ) of the object Sⱼ at that time tᵢ. In this case, the relationship ρ_{i,i′}^{(j)} may be a displacement from the position rⱼ(tᵢ) of the object Sⱼ at the time tᵢ to a position rⱼ(t_{i′}) of the object Sⱼ at the time t_{i′}. In this case, the position rⱼ(tᵢ), the position rⱼ(t_{i′}), and the relationship ρ_{i,i′}^{(j)} are each represented by a three-dimensional vector, and a relationship of rⱼ(t_{i′})=ρ_{i,i′}^{(j)}+rⱼ(tᵢ) holds among these vectors. Therefore, the model generation unit 21 can calculate the relationship ρ_{i,i′}^{(j)} according to, for example, ρ_{i,i′}^{(j)}=rⱼ(t_{i′})−rⱼ(tᵢ).

In addition, as an example without limiting the disclosure, the physical quantity oᵢ^{(j)} corresponding to each time tᵢ may be a pose qⱼ(tᵢ) of the object Sⱼ at that time tᵢ. In this case, the relationship ρ_{i,i′}^{(j)} may be a pose change from the pose qⱼ (tᵢ) of the object Sⱼ at the time tᵢ to a pose qⱼ (t_{i′}) of the object Sⱼ at the time tᵢ′. In this case, the pose qⱼ(tᵢ), the pose qⱼ(t_{i′}), and the relationship ρ_{i,i′}^{(j)} are each represented by a quaternion, and a relationship of qⱼ(t_{i′})=ρ_{i,i′}^{(j)}*qⱼ(tᵢ) holds among these quaternions. Therefore, the model generation unit 21 can calculate the relationship ρ_{i,i′}^{(j)} according to, for example, ρ_{i,i′}^{(j)}=qⱼ (t_{i′})/qⱼ(tᵢ).

In addition, as an example without limiting the disclosure, the physical quantity oᵢ^{(j)} corresponding to each time tᵢ may be a combination of the position rⱼ(tᵢ) and the pose qⱼ(tᵢ) of the object Sⱼ at the time tᵢ. In this case, the relationship ρ_{i,i′}^{(j)} can be a combination of the displacement from the position rⱼ(tᵢ) of the object Sⱼ at the time tᵢ to the position rⱼ(t_{i′}) of the object Sⱼ at the time t_{i′} and the pose change from the pose qⱼ(tᵢ) of the object Sⱼ at the time t₁ to the pose qⱼ (t_{i′}) of the object Sⱼ at the time t_{i′}.

Note that, instead of using the pair (Zᵢ^{(j)}, Z_{i′}^{(j)}) of latent variables Zᵢ^{(j)} and Z_{i′}^{(j)} as the input of the regression model M1, a difference Z_{i′}^{(j)}−Zᵢ^{(j)} between the latent variables Zᵢ^{(j)} and Z_{i′}^{(j)} may be used as the input of the regression model M1. In this case, the model generation unit 21 generates the regression model M1 for deriving the relationship ρ_{i,i′}^{(j)} between the physical quantities oᵢ^{(j)} and o_{i′}^{(j)} from the difference Z_{i′}^{(j)}−Zᵢ^{(j)} between the latent variables Zᵢ^{(j)} and Z_{i′}^{(j)}.

In addition, instead of using the pair (Zᵢ^{(j)}, Z_{i′}^{(j)}) of latent variables Zᵢ^{(j)} and Z_{i′}^{(j)} as the input of the regression model M1, a set (Zᵢ^{(j)}, Z_{i′}^{(j)}, Z_{i′}^{(j)}−Zᵢ^{(j)}) of the latent variable Zᵢ^{(j)}, the latent variable Z_{i′}^{(j)} and the difference Z_{i′}^{(j)}−Zᵢ^{(j)} may be used as the input of the regression model M1. In this case, the model generation unit 21 generates the regression model M1 for deriving the relationship ρ_{i,i′}^{(j)} between the physical quantities oᵢ^{(j)} and o_{i′}^{(j)} from the set (Zᵢ^{(j)}, Z_{i′}^{(j)}, Z_{i′}^{(j)}−Zᵢ^{(j)}) of the latent variable Zᵢ^{(j)}, the latent variable Z_{i′}^{(j)}, and the difference Z_{i′}^{(j)}−Zᵢ^{(j)}.

### (Flow of Information Processing Method)

A flow of an information processing method S2 will be described with reference to FIG. 8. FIG. 8 is a flowchart illustrating the flow of the information processing method S2.

As illustrated in FIG. 8, the information processing method S2 includes a model generation process S21. Note that the information processing method S2 is executed by the information processing apparatus 2 or a computer, for example.

The model generation process S21 is a process for generating the regression model M1 for deriving, from a pair (Zᵢ^{(j)}, Z_{i′}^{(j)}) of latent variables Zᵢ^{(j)} and Z_{i′}^{(j)} corresponding to two different times tᵢ and t_{i′} (tᵢ<t_{i′}) output from the world model M0, a relationship ρ_{i,i′}^{(j)} between physical quantities oᵢ^{(j)} and o_{i′}^{(j)} corresponding to the two times tᵢ and t_{i′} for each object Sⱼ included in an object group {S₁, S₂, . . . , Sₘ} or for a specific object Sⱼ selected from the object group {S₁, S₂, . . . , Sₘ}. Note that the two times tᵢ and t_{i′} may be two adjacent (continuous) times, such as a time t₁ and a time t₂, or may be two non-adjacent (non-continuous) times, such as the time t₁ and a time t₃. Note that the model generation process S21 is executed, for example, by the model generation unit 21 of the information processing apparatus 2 or by a processor of the computer.

In the model generation process S21, the data set DS including the physical quantity oᵢ^{(j)} corresponding to each time tᵢ is used for each object Sⱼ included in the object group {S₁, S₂, . . . , Sₘ} or for the specific object Sⱼ selected from the object group {S₁, S₂, . . . , Sₘ} in order to generate the regression model M1. In the model generation process S21, the regression model M1 is trained such that a correspondence between input and output of the regression model M1 best approximates a correspondence between a pair (Zᵢ^{(j)}, Zᵢ^{(j)}) of latent variables Zᵢ^{(j)} and Z_{i′}^{(j)} corresponding to two different times tᵢ and t_{i′} acquired from the world model M0 and a relationship ρ_{i,i′}^{(j)} between physical quantities oᵢ^{(j)} and o_{i′}^{(j)} corresponding to the two times tᵢ and t_{i′} acquired from the data set DS.

Note that a physical quantity corresponding to each time tᵢ constituting the data set DS may be a relative physical quantity oᵢ^{(j)} or an absolute physical quantity Oᵢ^{(j)}. This is because a relationship between absolute physical quantities Oᵢ^{(j)} and O_{i′}^{(j)} corresponding to the two times tᵢ and t_{i′} coincides with the relationship ρ_{i,i′}^{(j)} between the relative physical quantities oᵢ^{(j)} and o_{i′}^{(j)} corresponding to the two times tᵢ and t_{i′}.

In addition, instead of using the pair (Zᵢ^{(j)}, Z_{i′}^{(j)}) of latent variables Zᵢ^{(j)} and Z_{i′}^{(j)} as the input of the regression model M1, a difference Z_{i′}^{(j)}−Zᵢ^{(j)} between the latent variables Zᵢ^{(j)} and Z_{i′}^{(j)} may be used as the input of the regression model M1. In this case, the regression model M1 for deriving the relationship ρ_{i,i′}^{(j)} between the physical quantities oᵢ^{(j)} and o_{i′}^{(j)} from the difference Z_{i′}^{(j)}−Zᵢ^{(j)} between the latent variables Zᵢ^{(j)} and Z_{i′}^{(j)} is generated in the model generation process S21.

In addition, instead of using the pair (Zᵢ^{(j)}, Z_{i′}^{(j)}) of latent variables Zᵢ^{(j)} and Z_{i′}^{(j)} as the input of the regression model M1, a set (Zᵢ^{(j)}, Z_{i′}^{(j)}, Z_{i′}^{(j)}−Zᵢ^{(j)}) of the latent variable Zᵢ^{(j)}, the latent variable Z_{i′}^{(j)}, and the difference Z_{i′}^{(j)}−Zᵢ^{(j)} may be used as the input of the regression model M1. In this case, in the model generation process S21, the regression model M1 for deriving the relationship ρ_{i,i′}^{(j)} between the physical quantities oᵢ^{(j)} and o_{i′}^{(j)} is generated from the set (Zᵢ^{(j)}, Z_{i′}^{(j)}, Z_{i′}^{(j)}−Zᵢ^{(j)}) of the latent variable Zᵢ^{(j)}, the latent variable Z_{i′}^{(j)}, and the difference Z_{i′}^{(j)}−Zᵢ^{(j)}.

### (Effects of Information Processing Apparatus and Information Processing Method)

In the information processing apparatus 2 and the information processing method S2, instead of the configuration of generating the regression model that regresses the physical quantity oᵢ^{(j)} corresponding to the time tᵢ from the latent variable Zᵢ^{(j)} corresponding to the time tᵢ, the configuration of generating the regression model M1 that regresses the relationship ρ_{i,i′}^{(j)} between the physical quantities oᵢ^{(j)} and o_{i′}^{(j)} corresponding to the times tᵢ and t_{i′} from the latent variables Zᵢ^{(j)} and Z_{i′}^{(j)} for the different times tᵢ and t_{i′} is adopted. Therefore, it is possible to generate the regression model M1 that does not depend on a coordinate system representing a physical quantity. Therefore, it is possible to reduce the instability of a regression result in a case where the regression model is used.

In addition, in the configuration in which the physical quantity oᵢ^{(j)} corresponding to the time tᵢ is regressed from the latent variable Zᵢ^{(j)} corresponding to the time tᵢ, there may be a problem that the operation of a non-learning object (an object not included as a subject in an image used for learning of the regression model) cannot be guaranteed because an object coordinate system is not defined. On the other hand, such a problem hardly occurs in the information processing apparatus 2 and the information processing method S2 since the configuration in which the relationship ρ_{i,i′}^{(j)} between the physical quantities oᵢ^{(j)} and o_{i′}^{(j)} corresponding to the different times tᵢ and t_{i′} is regressed from the latent variables Zᵢ^{(j)} and Z_{i′}^{(j)} at the times tᵢ and t_{i′} is adopted.

### Fifth Example Embodiment

A fifth example embodiment, which is an example of an embodiment, will be described in detail with reference to the drawings. Components having the same functions as the components described in the above-described example embodiments are denoted by the same reference signs, and the description thereof will be appropriately omitted. Note that an application range of each technique adopted in the present example embodiment is not limited to the present example embodiment. That is, each technique adopted in the present example embodiment can also be adopted in the other example embodiments included in the present disclosure within a range in which no particular technical problem occurs. In addition, each technique illustrated in each of the drawings referred to for describing the present example embodiment can be employed in the other example embodiments included in the present disclosure within a range in which no particular technical problem occurs.

### (Configuration of Information Processing Apparatus)

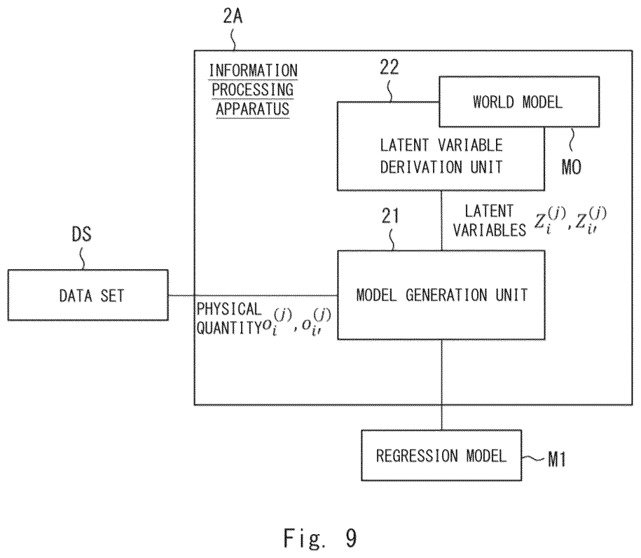

Next, a configuration of an information processing apparatus 2A will be described with reference to FIG. 9. FIG. 9 is a block diagram illustrating the configuration of the information processing apparatus 2A.

As illustrated in FIG. 9, the information processing apparatus 2A is obtained by adding a latent variable derivation unit 22 to the information processing apparatus 2 (see the fourth example embodiment).

The latent variable derivation unit 22 is a means for deriving latent variables Zᵢ^{(j)} and Z_{i′}^{(j)} corresponding to two different times tᵢ and t_{i′} using the world model M0 for each object Sⱼ included in an object group {S₁, S₂, . . . , Sₘ} or for a specific object Sⱼ selected from the object group {S₁, S₂, . . . , Sₘ}. In a case where a time tᵢ is included in an inference period, the latent variable derivation unit 12 obtains a latent variable Zᵢ^{(j)} corresponding to the time tᵢ by inputting an image Iᵢ corresponding to the time tᵢ and a latent variable Zᵢ₋₁^{(j)} corresponding to a time tᵢ₋₁ to the world model M0. In addition, in a case where a time t_{i′} is included in the inference period, a latent variable Z_{i′}^{(j)} corresponding to the time t_{i′} is similarly obtained. On the other hand, in a case where a time tᵢ is included in a prediction period, the latent variable derivation unit 12 obtains a latent variable Zᵢ^{(j)} corresponding to the time tᵢ by inputting a latent variable Zᵢ₋₁^{(j)} corresponding to a time tᵢ₋₁ to the world model M0. In addition, in a case where a time tᵢ is included in the prediction period, a latent variable Z_{i′}^{(j)} corresponding to the time t_{i′} is similarly obtained.

The model generation unit 21 of the information processing apparatus 2A trains the regression model M1 such that a correspondence between input and output of the regression model M1 best approximates a correspondence between a pair (Zᵢ^{(j)}, Z_{i′}^{(j)}) of latent variables Zᵢ^{(j)} and Z_{i′}^{(j)} corresponding to two different times tᵢ and t_{i′} acquired from the latent variable derivation unit 22 and a relationship ρ_{i,i′}^{(j)} between physical quantities oᵢ^{(j)} and o_{i′}^{(j)} corresponding to the two times tᵢ and t_{i′} acquired from the data set DS.

### (Flow of Information Processing Method)

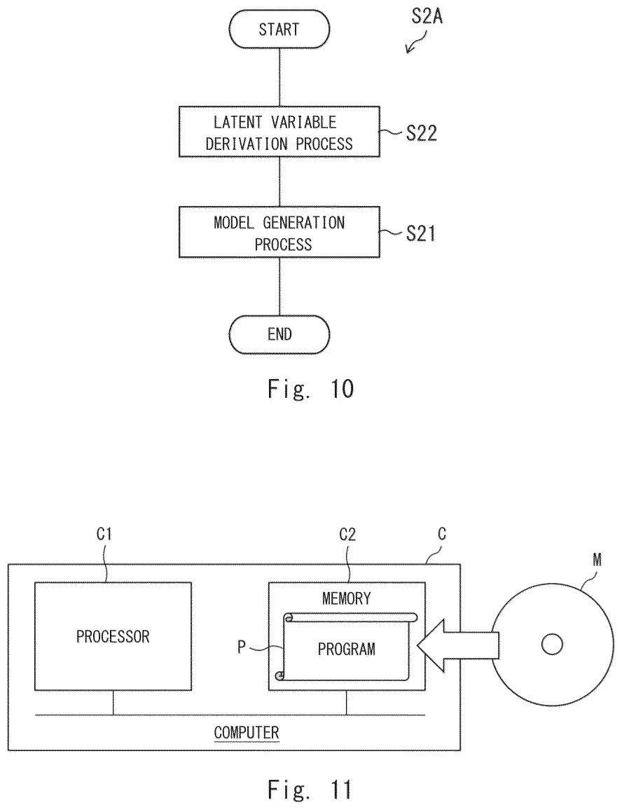

A flow of an information processing method S2A will be described with reference to FIG. 10. FIG. 10 is a flowchart illustrating the flow of the information processing method S2A.

As illustrated in FIG. 10, the information processing method S2A is obtained by adding a latent variable derivation process S22 to the information processing method S2 (see the fourth example embodiment). Note that the information processing method S2A is executed by, for example, the information processing apparatus 2A or a computer.

As illustrated in FIG. 10, the latent variable derivation process S22 is executed before the model generation process S21.

The latent variable derivation process S22 is a process for deriving latent variables Zᵢ^{(j)} and Z_{i′}^{(j)} corresponding to two different times tᵢ and t_{i′} using the world model M0 for each object Sⱼ included in an object group {S₁, S₂, . . . , Sₘ} or for a specific object Sⱼ selected from the object group {S₁, S₂, . . . , Sₘ}. In a case where a time tᵢ is included in an inference period, in the latent variable derivation process S12, a latent variable Zᵢ^{(j)} corresponding to the time tᵢ is obtained by inputting an image Iᵢ corresponding to the time t₁ and a latent variable Zᵢ₋₁^{(j)} corresponding to a time tᵢ₋₁ to the world model M0. In addition, in a case where a time t_{i′} is included in the inference period, a latent variable Z_{i′}^{(j)} corresponding to the time t_{i′} is similarly obtained. On the other hand, in a case where a time tᵢ is included in a prediction period, in the latent variable derivation process S12, a latent variable Zᵢ^{(j)} corresponding to the time tᵢ is obtained by inputting a latent variable Zᵢ₋₁^{(j)} corresponding to a time tᵢ₋₁ to the world model M0. In addition, in a case where a time t_{i′} is included in the inference period, a latent variable Z_{i′}^{(j)} corresponding to the time t_{i′} is similarly obtained. Note that the latent variable derivation process S22 is executed, for example, by the latent variable derivation unit 22 of the information processing apparatus 2A or by a processor of the computer.

In the model generation process S21 of the information processing method S2A, the regression model M1 is trained such that a correspondence between input and output of the regression model M1 best approximates a correspondence between a pair (Zᵢ^{(j)}, Z_{i′}^{(j)}) of latent variables Zᵢ^{(j)} and Z_{i′}^{(j)} corresponding to two different times tᵢ and t_{i′} acquired from the latent variable derivation unit 22 and a relationship ρ_{i,i′}^{(j)} between physical quantities oᵢ^{(j)} and o_{i′}^{(j)} corresponding to the two times tᵢ and t_{i′} acquired from the data set DS.

### (Effects of Information Processing Apparatus and Information Processing Method)

In the information processing apparatus 2A and the information processing method S2A, instead of the configuration of generating the regression model that regresses the physical quantity oᵢ^{(j)} corresponding to the time tᵢ from the latent variable Zᵢ^{(j)} corresponding to the time tᵢ, the configuration of generating the regression model M1 that regresses the relationship ρ_{i,i′}^{(j)} between the physical quantities oᵢ^{(j)} and o_{i′}^{(j)} corresponding to the times tᵢ and t_{i′} from the latent variables Zᵢ^{(j)} and Z_{i′}^{(j)} for the different times tᵢ and t_{i′} is adopted. Therefore, it is possible to generate the regression model M1 that does not depend on a coordinate system representing a physical quantity. Therefore, it is possible to reduce the instability of a regression result in a case where the regression model is used.

In addition, in the configuration in which the physical quantity oᵢ^{(j)} corresponding to the time tᵢ is regressed from the latent variable Zᵢ^{(j)} corresponding to the time tᵢ, there may be a problem that the operation of a non-learning object (an object not included as a subject in an image used for learning of the regression model) cannot be guaranteed because an object coordinate system is not defined. On the other hand, such a problem hardly occurs in the information processing apparatus 2A and the information processing method S2A since the configuration in which the relationship ρ_{i,i′}^{(j)} between the physical quantities oᵢ^{(j)} and o_{i′}^{(j)} corresponding to the different times tᵢ and t_{i′} is regressed from the latent variables Zᵢ^{(j)} and Z_{i′}^{(j)} at the times tᵢ and t_{i′} is adopted.

### [Example of Implementation by Software]

Some or all of the functions of the information processing apparatuses 1, 1A, 1B, 2, and 2A (hereinafter, also referred to as “each of the above apparatuses”) may be implemented by hardware such as an integrated circuit (IC chip) or may be implemented by software.

In the latter case, each of the above apparatuses is implemented by, for example, a computer that executes a command of a program which is software for implementing each function. An example of such a computer (hereinafter, referred to as a computer C) is illustrated in FIG. 11. FIG. 11 is a block diagram illustrating a hardware configuration of the computer C functioning as each of the above apparatuses.

The computer C includes at least one processor C1 and at least one memory C2. A program P for causing the computer C to operate as each of the above apparatuses is recorded in the memory C2. In the computer C, the processor C1 reads the program P from the memory C2 and executes the program P to implement each function of each of the above apparatuses.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

Note that the computer C may further include a random access memory (RAM) for developing the program P at the time of execution and temporarily storing various types of data. In addition, the computer C may further include a communication interface for transmitting and receiving data to and from other apparatuses. The computer C may further include an input/output interface for connecting input/output apparatuses such as a keyboard, a mouse, a display, and a printer.

In addition, the program P can be recorded on a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. In addition, the program P can be transmitted via a transmission medium. As such a transmission medium, for example, a communication network, a broadcast wave, or the like can be used. The computer C can also acquire the program P via such a transmission medium.

In addition, each of the above functions of each of the above apparatuses may be implemented by a single processor provided in a single computer, may be implemented by cooperation of a plurality of processors provided in a single computer, or may be implemented by cooperation of a plurality of processors provided in a plurality of computers, respectively. In addition, the program for causing each of the above apparatuses to implement each of the above functions may be stored in a single memory provided in a single computer, may be stored in a distributed manner in a plurality of memories provided in a single computer, or may be stored in a distributed manner in a plurality of memories provided in a plurality of computers, respectively.

### APPENDIX 1

The whole or part of the example embodiments disclosed above can be described as, but not limited to, the following supplementary notes.

### (Supplementary Note 1)

An information processing apparatus including a relationship derivation means for deriving, for an object included in a world model representing a state of the object as a latent variable, a relationship between physical quantities from a pair of the latent variables using a regression model having the pair of latent variables corresponding to different times output from the world model as an input and having the relationship between the physical quantities respectively corresponding to the different times as an output.

### (Supplementary Note 2)

The information processing apparatus according to Supplementary Note 1, further including a latent variable derivation means for deriving the latent variable using the world model,
wherein the relationship derivation means derives the relationship between the physical quantities from a pair of the latent variables derived by the latent variable derivation means.

### (Supplementary Note 3)

The information processing apparatus according to Supplementary Note 1, further including a physical quantity calculation means for calculating the physical quantity corresponding to a later time out of the different times from the physical quantity corresponding to an earlier time out of the different times and the relationship between the physical quantities derived by the relationship derivation means.

### (Supplementary Note 4)

The information processing apparatus according to Supplementary Note 3, wherein
the physical quantities are positions of the object,
the relationship derivation means derives a vector representing a displacement from the position of the object at the earlier time out of the different times to the position of the object at the later time out of the different times, and
the physical quantity calculation means adds a vector representing the position of the object at the earlier time out of the different times and a vector representing the displacement derived by the relationship derivation means to calculate a vector representing the position of the object at the later time out of the different times.

### (Supplementary Note 5)

The information processing apparatus according to Supplementary Note 3, wherein
the physical quantities are poses of the object,
the relationship derivation means derives a quaternion representing a pose change from the pose of the object at the earlier time out of the different times to the pose of the object at the later time out of the different times, and
the physical quantity calculation means multiplies the quaternion representing the pose of the object at the earlier time out of the different times by the quaternion representing the pose change derived by the relationship derivation means to calculate a quaternion representing the pose of the object at the later time out of the different times.

### (Supplementary Note 6)

The information processing apparatus according to any one of Supplementary Notes 3 to 5, further including a coordinate conversion means for referring to an absolute physical quantity corresponding to an initial time and converting the physical quantity at the later time out of the different times, the physical quantity being relative and calculated by the physical quantity calculation means, into the physical quantity that is absolute and corresponds to the later time out of the different times.

### (Supplementary Note 7)

An information processing apparatus including a model generation means for generating a regression model that uses, for an object included in a world model representing a state of the object as a latent variable, a pair of the latent variables corresponding to different times output from the world model as an input and uses a relationship between physical quantities respectively corresponding to the different times as an output,
wherein the model generation means generates the regression model in such a manner that a correspondence between the input and the output of the regression model best approximates a correspondence between the pair of latent variables output from the world model and a relationship between the physical quantities acquired from a data set.

### (Supplementary Note 8)

The information processing apparatus according to Supplementary Note 7, further including a latent variable derivation means for deriving the latent variables using the world model,
wherein the model generation means generates the regression model in such a manner that a correspondence between the input and the output of the regression model best approximates a correspondence between a pair of the latent variable acquired from the latent variable derivation means and the relationship between the physical quantities acquired from the data set.

### (Supplementary Note 9)

An information processing method including deriving, by a processor, for an object included in a world model representing a state of the object as a latent variable, a relationship between physical quantities from a pair of the latent variables using a regression model having the pair of latent variables corresponding to different times output from the world model as an input and having the relationship between the physical quantities respectively corresponding to the different times as an output.

### (Supplementary Note 10)

An information processing method including generating, by a processor, a regression model that uses, for an object included in a world model representing a state of the object as a latent variable, a pair of the latent variables corresponding to different times output from the world model as an input and uses a relationship between physical quantities respectively corresponding to the different times as an output,
wherein the processor generates the regression model in such a manner that a correspondence between the input and the output of the regression model best approximates a correspondence between a pair of latent variables output from the world model and a relationship between the physical quantities acquired from a data set.

### (Supplementary Note 11)

A non-transitory computer-readable medium storing an information processing program causing a processor to execute a relationship derivation process of deriving, for an object included in a world model representing a state of the object as a latent variable, a relationship between physical quantities from a pair of the latent variables using a regression model having the pair of latent variables corresponding to different times output from the world model as an input and having the relationship between the physical quantities respectively corresponding to the different times as an output.

### (Supplementary Note 12)

A non-transitory computer-readable medium storing an information processing program for causing a processor to execute a model generation process of generating a regression model that uses, for an object included in a world model representing a state of the object as a latent variable, a pair of the latent variables corresponding to different times output from the world model as an input and uses a relationship between physical quantities respectively corresponding to the different times as an output,
wherein, in the model generation process, the processor generates the regression model in such a manner that a correspondence between the input and the output of the regression model best approximates a correspondence between a pair of latent variables output from the world model and a relationship between the physical quantities acquired from a data set.

### (Supplementary Note 13)

An information processing apparatus including at least one processor,
wherein the at least one processor executes a relationship derivation process of deriving, for an object included in a world model representing a state of the object as a latent variable, a relationship between physical quantities from a pair of the latent variables using a regression model having the pair of latent variables corresponding to different times output from the world model as an input and having the relationship between the physical quantities respectively corresponding to the different times as an output.

Note that the information processing apparatus may further include a memory. In addition, the memory may store a program for causing the at least one processor to execute the process.

### (Supplementary Note 14)

An information processing apparatus including at least one processor, wherein
the at least one processor executes a model generation process of generating a regression model that uses, for an object included in a world model representing a state of the object as a latent variable, a pair of the latent variables corresponding to different times output from the world model as an input and uses a relationship between physical quantities respectively corresponding to the different times as an output, and
the at least one processor, in the model generation process, generates the regression model in such a manner that a correspondence between the input and the output of the regression model best approximates a correspondence between a pair of latent variables output from the world model and a relationship between the physical quantities acquired from a data set.

Note that the information processing apparatus may further include a memory. In addition, the memory may store a program for causing the at least one processor to execute the process.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments. Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

What is claimed is:

1. An information processing apparatus comprising:
at least one memory storing instructions; and
at least one processor configured to execute the instructions to derive, for an object included in a world model representing a state of the object as a latent variable, a relationship between physical quantities from a pair of the latent variables using a regression model having the pair of latent variables corresponding to different times output from the world model as an input and having the relationship between the physical quantities respectively corresponding to the different times as an output.

2. The information processing apparatus according to claim 1, wherein the processor is further configured to execute the instructions to:
derive the latent variable using the world model, and
derive the relationship between the physical quantities from a pair of the derived latent variables.

3. The information processing apparatus according to claim 1, wherein the processor is further configured to execute the instructions to calculate the physical quantity corresponding to a later time out of the different times from the physical quantity corresponding to an earlier time out of the different times and the derived relationship between the physical quantities.

4. The information processing apparatus according to claim 3, wherein
the physical quantities are positions of the object,
the processor is further configured to execute the instructions to:
derive a vector representing a displacement from the position of the object at the earlier time out of the different times to the position of the object at the later time out of the different times; and
add a vector representing the position of the object at the earlier time out of the different times and the derived vector representing the displacement to calculate a vector representing the position of the object at the later time out of the different times.

5. The information processing apparatus according to claim 3, wherein
the physical quantities are poses of the object,
the processor is further configured to execute the instructions to:
derive a quaternion representing a pose change from the pose of the object at the earlier time out of the different times to the pose of the object at the later time out of the different times; and
multiply a quaternion representing the pose of the object at the earlier time out of the different times by the derived quaternion representing the pose change to calculate a quaternion representing the pose of the object at the later time out of the different times.

6. The information processing apparatus according to claim 3, wherein the processor is further configured to execute the instructions to:
refer to an absolute physical quantity corresponding to an initial time; and
convert the calculated physical quantity at the later time out of the different times, the physical quantity being relative, into the physical quantity that is absolute and corresponds to the later time out of the different times.

7. An information processing method comprising deriving, by a processor, for an object included in a world model representing a state of the object as a latent variable, a relationship between physical quantities from a pair of the latent variables using a regression model having the pair of latent variables corresponding to different times output from the world model as an input and having the relationship between the physical quantities respectively corresponding to the different times as an output.

8. A non-transitory computer-readable medium storing an information processing program causing a processor to execute a relationship derivation process of deriving, for an object included in a world model representing a state of the object as a latent variable, a relationship between physical quantities from a pair of the latent variables using a regression model having the pair of latent variables corresponding to different times output from the world model as an input and having the relationship between the physical quantities respectively corresponding to the different times as an output.
